(19) United States
(12) Patent Application Publication
(10) Pub. No.: US 2023/0394112 A1
(43) Pub. Date: Dec. 7, 2023

(54) GRAPH-BASED SEMI-SUPERVISED GENERATION OF FILES

(71) Applicant: INTERNATIONAL BUSINESS MACHINES CORPORATION, ARMONK, NY (US)

(72) Inventors: PABLO SALVADOR LOYOLA HEUFEMANN, Tokyo (JP); Harikrishnan Balagopal, Thrissur (IN); Padmanabha Venkatagiri Seshadri, Mysore (IN); Akash Nayak, Raipur (IN); Ashok Pon Kumar Sree Prakash, Bangalore (IN); Amith Singhee, Bangalore (IN)

(21) Appl. No.: 17/805,310

(22) Filed: Jun. 3, 2022

(51) Int. Cl. G06K 9/62; G06F 16/28; G06F 16/2457; G06F 16/2455

(52) U.S. Cl. CPC G06K 9/6256; G06F 16/288; G06F 16/2457; G06K 9/6215; G06F 16/2455

(57) ABSTRACT

A processor may collect a set of repositories. The processor may filter the set of repositories based on one or more predefined rules. The processor may obtain a high-quality subset from the set of repositories. The high-quality subset may include one or more datum. The processor may split the one or more datum into a high-quality dataset and an uncertain dataset.

### BACKGROUND

The present disclosure relates generally to the field of file generation, and more specifically to semi-supervised file generation.

Files, such as Dockerfiles associated with Docker®, are the main artifact used for containerization. Said files are generally a sequence of (command, value) pairs that instruct build and deploy (e.g., run) tasks. However, said files: need to be constructed manually, have a lack of standards and security aspects, and every application requires a specific file.

### SUMMARY

Embodiments of the present disclosure include a method, computer program product, and system for graph-based semi-supervised generation of files. A processor may collect a set of repositories. The processor may filter the set of repositories based on one or more predefined rules. The processor may obtain a high-quality subset from the set of repositories. The high-quality subset may include one or more datum. The processor may split the one or more datum into a high-quality dataset and an uncertain dataset.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example system for graph-based semi-supervised generation of files, in accordance with aspects of the present disclosure.

FIG. 2 illustrates a flowchart of an example method for graph-based semi-supervised generation of files, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of file generation, and more specifically to semi-supervised file generation. While the present disclosure is not necessarily limited to such applications, various aspects of the disclosure may be appreciated through a discussion of various examples using this context.

Files, such as Dockerfiles associated with Docker®, are the main artifact used for containerization. Said files are generally a sequence of (command, value) pairs that instruct build and deploy (e.g., run) tasks. However, said files: need to be constructed manually and have a lack of standards and security aspects, further, every application requires a specific file.

Accordingly, disclosed herein is a proposed solution (e.g., method, system, and/or computer program product) that alleviates: the need for said files to be constructed manually, said files having a lack of standards and security aspects, and the need for every application requiring a specific file.

The proposed solution is able to learn from large amounts of existing files (e.g., Dockerfiles, a corpus/database of files, etc.) and automatically generate feasible files for an unseen codebase. Noted is that another issue with using files retrieved from large amounts of existing files is noise, which makes a considerable proportion of the files unable to be run; so much so that files pulled form large amounts of existing files contain up-to five times more violations than files written/curated by experts. Consequently, the proposed solution utilizes a semi-supervised technique to consider a small set of high quality files as labeled set for generation (e.g., into a single file). It is noted that traditional solutions provide for no direct method for Dockerfile generation and are only limited to automatic repair Dockerfiles with syntactic/semantic errors.

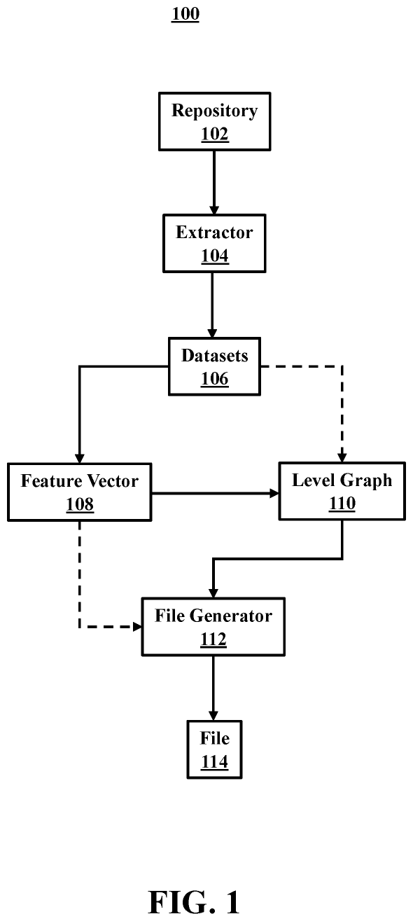

Referring now to FIG. 1, illustrated is a block diagram of an example system 100 for graph-based semi-supervised generation of files, in accordance with aspects of the present disclosure. As depicted, the system 100 includes a repository 102, an extractor 104, datasets 106, a feature vector 108, a level graph 110, a file generator 112, and a file 114.

In some embodiments, the repository 102 contains one or more files that are along with, or include, a codebase. In some embodiments, the extractor 104 extracts the one or more files and/or the codebase. The one or more files and/or the codebase are then filtered by a set of rules (e.g., inactive for X amount of time, etc.) to obtain a high-quality subset of the one or more files and/or codebase (e.g., the obtained subset(s) are likely to relate to the file that is needed to be generated). In some embodiments, the extractor 104 may filter the one or more files and/or codebase, or in other embodiments, another specialized component of the system 100 could perform the filtering/obtaining. In some embodiments, the obtained high-quality subset is described is included, or described as, the datasets 106 (e.g., there are more than one high-quality subset in some instances).

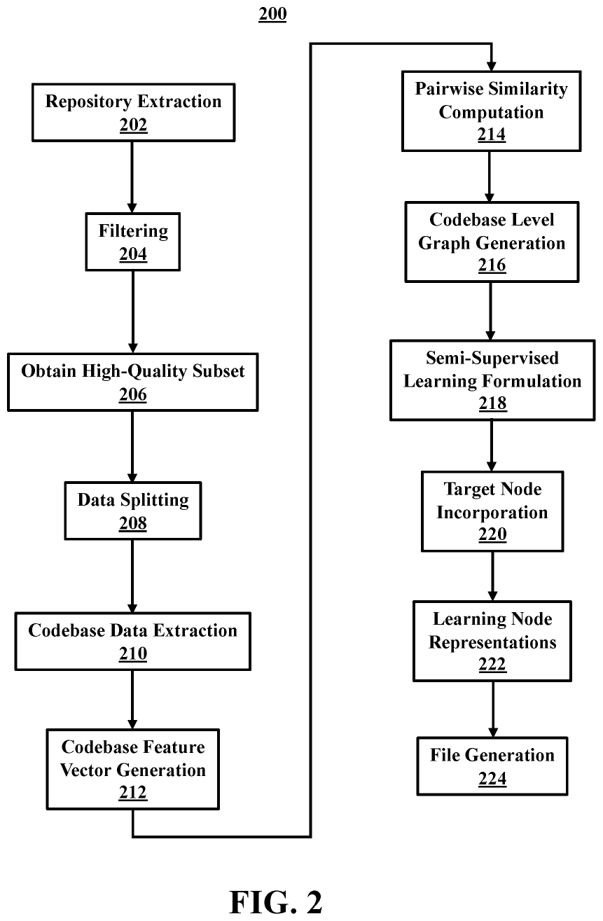

In some embodiments, the datasets 106 are analyzed to produce a feature vector 108, or feature vectors (which is discussed in more detail in regard to FIG. 2 below). In some embodiments, the datasets 106 could be optionally provided or analyzed to generated level graph 110 or level graphs (which is additionally discussed in more detail in regard to FIG. 2 below). In some embodiments, the feature vector 108 is utilized to generate the level graph 110.

In some embodiments, the feature vector 108 could be optionally provided to the file generator 112 (along with the level graph 110). In some embodiments, the level graph 110 is provided to the file generator 112 (e.g., with information incorporated from the feature vector 108.

In some embodiments, the file generator 112 utilizes at least the level graph 110 to generate the file 114 (e.g., Dockerfile), which may incorporate information and/or codebases from the datasets 106, and which is automatically generated for use by a user.

It is noted that not all steps and/or components of the system 100 are described, but are described in more detail below in regard to the method 200 of FIG. 2. Further noted is that the benefits provided by the system 100 are that input codebases from the repository 102, and/or associated with the datasets 106, are represented in terms of a diverse perspective, giving a richer representation, which in-turn avoids having to process all source code (e.g., data efficiency). Further, election/selection/determination of high-quality (e.g., runnable) files (e.g., the datasets 106) as a “golden set” provides a better signal for generation of the file 114 (e.g., or training for generation of the file 114). Lastly, transforming data of the datasets 106 (from the feature vector 108) into the level graph 110 allows to set up a smoother semi-supervised setting that allows label propagation across neighbors (e.g., learning nodes used for machine learning/training/etc.).

Referring now to FIG. 2, illustrated is a flowchart of an example method 200 for graph-based semi-supervised generation of files, in accordance with aspects of the present disclosure. In some embodiments, the method 200 may be performed by a processor (e.g., of the system 100 of FIG. 1, etc.).

In some embodiments, the method 200 begins at repository extraction 202. In some embodiments, for repository extraction 202, the processor collects a set of repositories that contain a file (e.g., a Dockerfile) along with a codebase (e.g., using Github® API). In some embodiments, the method 200 proceeds to filtering 204, where the processor filters out repositories based on (a set) predefined rules (e.g., the repository was inactive for M months, less than certain number of review stars, only contains Dockerfiles, etc.).

In some embodiments, the method 200 proceeds to obtain a high-quality subset 206 (that includes one or more datum). In some embodiments, the processor obtains a high-quality subset 206 by: 1) defining a proportion P, 2) sampling repositories from the one or more datum, 3) checking if a file is runnable, 4) determining if the file is runnable, to add the high-quality subset to the portion, and 5) repeating steps 1)-4) until the high-quality subset is of size P.

In some embodiments, the method 200 proceeds to data splitting 208, where the processor structures the data (e.g., one or more datum) into the high-quality subset and an uncertain set/subset (e.g., the one or more datum related to the uncertain set may meet some rules, but not a threshold number to be added to the high-quality subset. In some embodiments, each of the high-quality subset and the uncertain subset is a list of (codebase, file) coming from an associated repository. For example, the high-quality subset may be labeled as (H) and have a list of {codebase_U, Dockerfile_U}, and the uncertain subset may be labeled as (U) and have a list of {codebase_H, Dockerfile_H}.

In some embodiments, the method 200 proceeds to code base data extraction 210, where the processor, for each codebase in codebase_U and codebase_H obtains: 1) a list of configuration files, and 2) social meta information from select services (e.g., Github®), e.g., followers=(list of IDs), tags=(list of words), etc.

In some embodiments, the method 200 proceeds to codebase feature vector generation 212, where the processor parses down files (e.g., configuration files) and converts the file into a flat list of (key, value) pairs, where keys represent parameter names (e.g., [(port, 8080), (java_version, 1.8), (path. “some/path”), . . . ( )], etc.).

In some embodiments, for codebase feature vector generation 212, the processor further tags the vectors with words in natural language. In such an embodiment, each of the tags is associated to a dense pretrained vector, and the resulting set of vectors are compressed into one vector. In some embodiments, if data includes meta information of “followers”, a list of user IDs is used, and no processing required. In such an embodiment, in this way, each codebase can be represented by means of three vectors, each of them characterizing a different aspect.

In some embodiments, the method 200 proceeds to pairwise similarity computation 214, where the processor determines a total similarity that is a linear combination of per vector similarities. In some embodiments, a custom similarity is defined as a modified Jaccard index to account for the parameter values, e.g.,

Given two configuration file values: C1=[(k1, a), (k2, b)], C2=[(k1, a), (k3, d)] Custom similarity(C1, C2)=C1 INTER′ C2/C1 UNION C2, where INTER′=[k for k in C1 if k in C2 and C1[k]==C2[k] ]. In some embodiments, similarity is: Sim(i, j)=w1*Custom sim+w2*Cosine sim+w3*Jaccard, where w is a weighted value.

In some embodiments, the method 200 proceeds to codebase level graph generation 216, where the processor constructs an undirected graph based on how close each pair of codebase vectors are, as defined by a threshold T. At this point each node has a codebase vector and an associated file. In some embodiments, the method 200 proceeds to semi-supervised learning formulation 218, where the processor removes file information from nodes that belong to any uncertain subsets/datasets/quality groups.

In such an embodiment, the resulting graph has few labeled (e.g., with Dockerfile) nodes, and a larger set of unlabeled nodes. The unlabeled nodes serve as bridges to propagate generative capabilities throughout the graph structure.

In some embodiments, the method 200 proceeds to target node incorporation 220, where the processor incorporates a target node into a group of nodes that already contain at least a codebase vector, if not also a file/Dockerfile. For example, assume a user has codebase X, and wants to generate a Dockerfile for X. The processor would compute X's codebase vector(s) and incorporate them into the (level) graph (e.g., based on the same similarity threshold T).

In some embodiments, the method 200 proceeds to learning node representation 222, where the processor, using a codebase vector as an initial seed, and using a message passing algorithm learns a feature vector for all nodes. With this, each resulting vector is encoded with a relationship between each codebase and its surrounding neighbors. For example, node Y has codebase Z, which is associated with a specific function, and node Y is a neighbor to node A that has codebase B. The resulting vector between node Y and node A would include the relationship of their codebases Z and B.

In some embodiments, the method 200 proceeds to file generation 224, where the learned vectors are used in a semi-supervised setting and each vector is passed to a decoder that serves as an initial seed for generation. The processor then outputs, from the decoder, a sequence of tokens that represent a file (e.g., Dockerfile). In some embodiments, the processor computes loss on a labeled part of the graph, therefore learning affects all representations involved (e.g., both labeled and unlabeled).

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

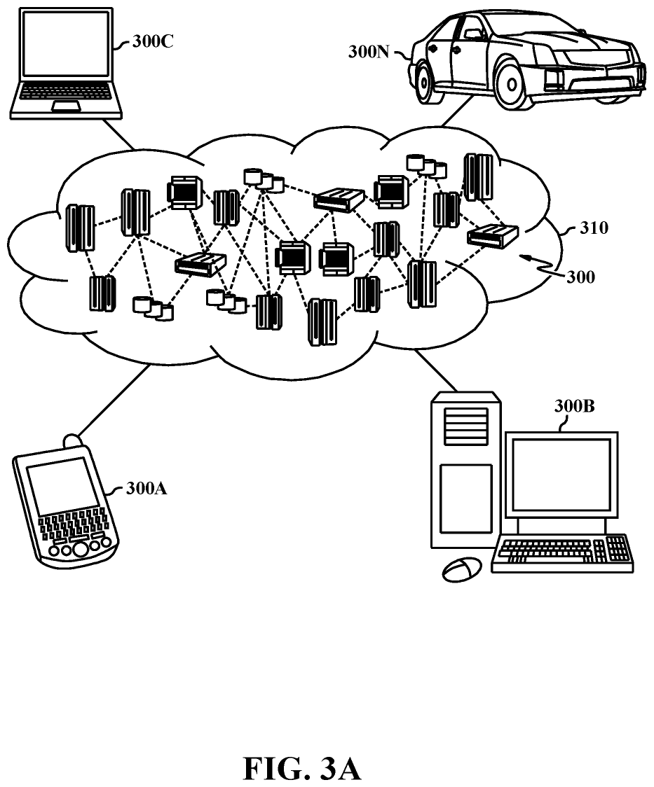

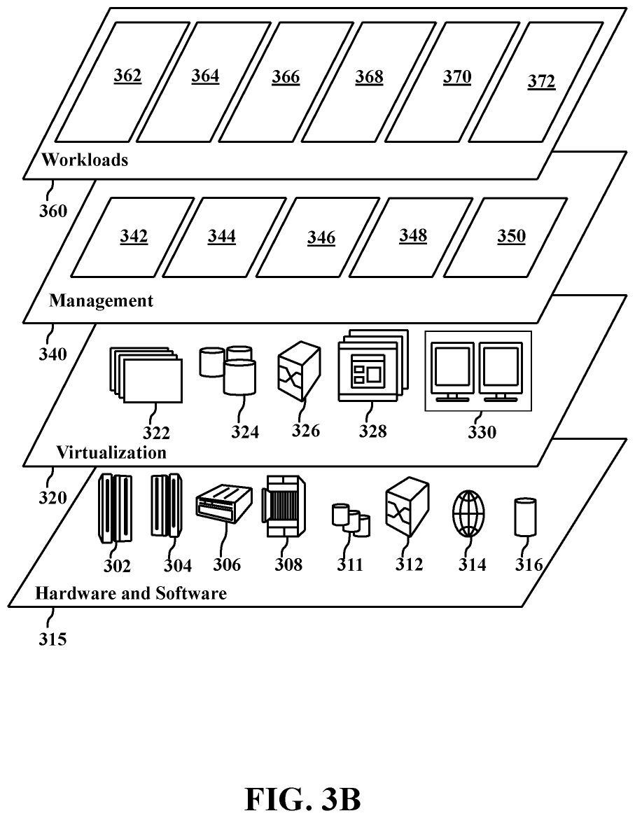

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and graph-based semi-supervised file generation 372.

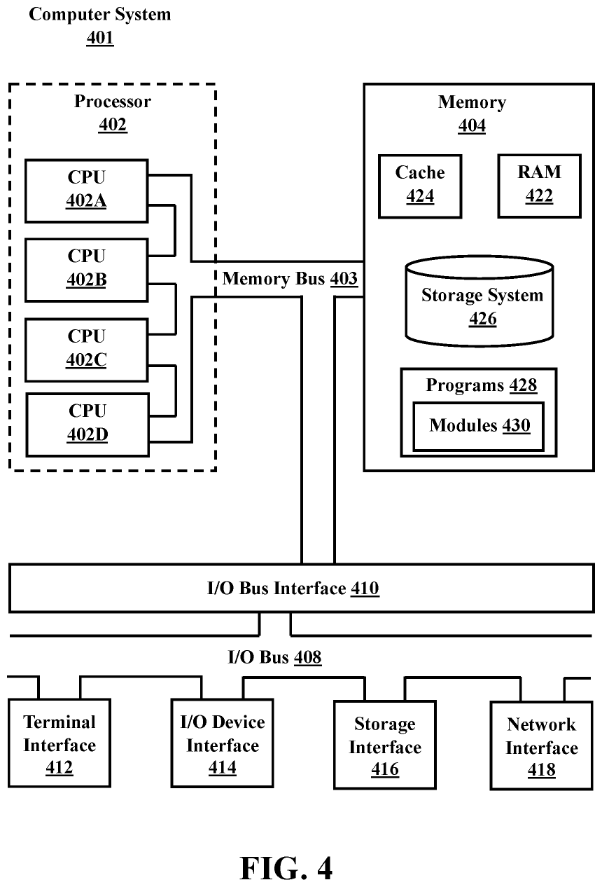

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A system for graph-based semi-supervised generation of files, the system comprising:
a memory; and
a processor in communication with the memory, the processor being configured to perform operations comprising:
collecting a set of repositories;
filtering the set of repositories based on one or more predefined rules;
obtain a high-quality subset from the set of repositories, wherein the high-quality subset includes one or more datum; and
splitting the one or more datum into a high-quality dataset and an uncertain dataset.

2. The system of claim 1, wherein the processor is further configured to perform operations comprising:
extracting, from the high-quality dataset and the uncertain dataset, respective codebases; and
generating one or more codebase feature vectors, wherein the one or more codebase feature vectors are associated with the high-quality dataset and the uncertain dataset.

3. The system of claim 2, wherein the processor is further configured to perform operations comprising:
computing a pairwise similarity utilizing the one or more codebase feature vectors; and
generating a codebase level graph.

4. The system of claim 3, wherein the processor is further configured to perform operations comprising:
performing a semi-supervised learning formulation; and
incorporating a target node.

5. The system of claim 4, wherein the processor is further configured to perform operations comprising:
generating one or more learning node representations.

6. The system of claim 5, wherein the processor is further configured to perform operations comprising:
generating a file, wherein the file is generated based on the one or more learning node representations, and wherein the file includes at least one of the one or more datum.

7. The system of claim 5, wherein the one or more learning node representations include at least the target node and one or more unlabeled nodes, and wherein the one or more unlabeled nodes are utilized as propagation bridges.

8. A computer-implemented method for graph-based semi-supervised generation of files, the method comprising:
collecting, by a processor, a set of repositories;
filtering the set of repositories based on one or more predefined rules;
obtain a high-quality subset from the set of repositories, wherein the high-quality subset includes one or more datum; and
splitting the one or more datum into a high-quality dataset and an uncertain dataset.

9. The computer-implemented method of claim 8, further comprising: and
extracting, from the high-quality dataset and the uncertain dataset, respective codebases;
generating one or more codebase feature vectors, wherein the one or more codebase feature vectors are associated with the high-quality dataset and the uncertain dataset.

10. The computer-implemented method of claim 9, further comprising:
computing a pairwise similarity utilizing the one or more codebase feature vectors; and
generating a codebase level graph.

11. The computer-implemented method of claim 10, further comprising:
performing a semi-supervised learning formulation; and
incorporating a target node.

12. The computer-implemented method of claim 11, further comprising:
generating one or more learning node representations.

13. The computer-implemented method of claim 12, further comprising:
generating a file, wherein the file is generated based on the one or more learning node representations, and wherein the file includes at least one of the one or more datum.

14. The computer-implemented method of claim 12, wherein the one or more learning node representations include at least the target node and one or more unlabeled nodes, and wherein the one or more unlabeled nodes are utilized as propagation bridges.

15. A computer program product for graph-based semi-supervised generation of files comprising a computer readable storage medium having program instructions embodied therewith, the program instructions executable by a processor to cause the processor to perform operations, the operations comprising:
collecting a set of repositories;
filtering the set of repositories based on one or more predefined rules;
obtain a high-quality subset from the set of repositories, wherein the high-quality subset includes one or more datum; and
splitting the one or more datum into a high-quality dataset and an uncertain dataset.

16. The computer program product of claim 15, wherein the processor is further configured to perform operations comprising:
extracting, from the high-quality dataset and the uncertain dataset, respective codebases; and
generating one or more codebase feature vectors, wherein the one or more codebase feature vectors are associated with the high-quality dataset and the uncertain dataset.

17. The computer program product of claim 16, wherein the processor is further configured to perform operations comprising:
computing a pairwise similarity utilizing the one or more codebase feature vectors; and
generating a codebase level graph.

18. The computer program product of claim 17, wherein the processor is further configured to perform operations comprising:
performing a semi-supervised learning formulation; and
incorporating a target node.

19. The computer program product of claim 18, wherein the processor is further configured to perform operations comprising:
generating one or more learning node representations.

20. The computer program product of claim 19, wherein the processor is further configured to perform operations comprising:
generating a file, wherein the file is generated based on the one or more learning node representations, and wherein the file includes at least one of the one or more datum.
